(19) United States
(12) Patent Application Publication
(10) Pub. No.: US 2013/0027447 A1
(43) Pub. Date: Jan. 31, 2013

(54) IMAGE FORMING APPARATUS AND IMAGE FORMING METHOD

(71) Applicant: Shinichi Hatanaka, Tokyo (JP)

(72) Inventor: Shinichi Hatanaka, Tokyo (JP)

(73) Assignee: RICOH COMPANY, LTD., Tokyo (JP)

(21) Appl. No.: 13/538,112

(22) Filed: Jun. 29, 2012

(30) Foreign Application Priority Data
Jul. 26, 2011 (JP) 2011-163610

(51) Int. Cl. B41J 29/38

(52) U.S. Cl. 347/5

(57) ABSTRACT

An image forming apparatus configured to form an image on a data sheet includes a pattern forming unit configured to form a predetermined pattern on the data sheet; a pattern reading unit configured to apply a process liquid to the data sheet on which the predetermined pattern is formed by the pattern forming unit, and to read the predetermined pattern on the data sheet after applying the process liquid; an expansion and contraction amount calculation unit configured to calculate an amount of expansion or contraction of the predetermined pattern read by the pattern reading unit; and an image data expansion and contraction unit configured to expand or contract image data depending on the amount of expansion or contraction calculated by the expansion and contraction calculation unit.

### BACKGROUND OF THE INVENTION

1. Field of the Invention

The present invention relates to an image forming apparatus and an image forming method.

2. Description of the Related Art

Conventionally, an ink-jet recording apparatus (which is called a “recording apparatus” hereinafter) is known as a recording apparatus that performs recording on a data sheet using a liquid such as ink and the like. This recording apparatus is provided with a conveyance mechanism that conveys the data sheet in a conveyance direction and a recording head that emits a jet of ink onto the data sheet conveyed into the recording apparatus by the conveyance mechanism. The recording apparatus, for example, if receiving image data from a host computer, emits jets of various inks onto the data sheet from the recording head, and records an image based on the image data on the data sheet.

Moreover, conventionally, for the purpose of image quality improvement such as reduction of an ooze and coloring improvement, and fixative enhancement between coloring material such as ink and a data sheet, applying a process liquid to the data sheet is known. Here, sometimes the data sheet expands or contracts by absorbing the process liquid that has been preliminarily applied, and may move in a manner opposite to the expansion or contraction by subsequent drying. Here, a degree of the expansion or contraction varies based on an installation environment of the recording apparatus (e.g., humidity and the like) or composition of the data sheet. If an image is recorded on such an expanded or contracted data sheet, the image on the data sheet may be enlarged or reduced to more or less than an intended size by the subsequent change of the data sheet due to the drying.

Therefore, conventionally, a method is known in which a process liquid is preliminarily applied to the data sheet between applying a first color liquid and a second color liquid; a position deviation amount is detected by using a first reference mark formed by the first color liquid and a second reference mark formed by the second color liquid; and a correction is performed by using the position deviation amount as disclosed in Japanese Patent Application Publication No. 2009-255523 (which is called “Patent Document 1” hereinafter). Moreover, conventionally, a method is known in which a deformation amount for a elapsed time after an application of a process liquid is preliminarily obtained, and a correction amount is obtained by using the deformation amount as disclosed in Japanese Patent Application Publication No. 2010-82935 (which is called “Patent Document 2” hereinafter). Furthermore, conventionally, a method is known in which an expansion or contraction state of a data sheet is understood by using a crop mark for measurement printed in margins of four corners on the surface of the data sheet, and an enlargement or reduction ratio of an image when the back is printed is determined as disclosed in Japanese Patent Application Publication No. 2005-223381 (which is called “Patent Document 3” hereinafter).

However, in the methods as disclosed in Patent Documents 1 and 2, preliminarily understanding the variation or the correction amount of the data sheet is needed, for which accumulation of data or a prior assessment is needed. In addition, since the correction value is not calculated at the timing of recording the image on the data sheet in real time, the correction is performed by just using a predicted correction value. Moreover, the variation of the data sheet differs depending on a lot number of the data sheet, a position in the surface of the data sheet, and application unevenness of the process liquid.

Furthermore, in the method as shown in Patent Document 3, the expanded or contracted state of the data sheet merely in the margins of the four corners of the surface of the data sheet is understood. Accordingly, as discussed above, a proper correction cannot be performed by detecting expanded and/or contracted states of respective parts caused by the application unevenness of the process liquid and the like.

### SUMMARY OF THE INVENTION

Accordingly, embodiments of the present invention may provide a novel and useful information processing apparatus and information processing method solving or reducing one or more of the above-described problems.

More specifically, the embodiments of the present invention may provide an image forming apparatus and an image forming method that perform a high-precision correction depending on an individual data sheet in real time.

According to one embodiment of the present invention, an image forming apparatus configured to form an image on a data sheet is provided, the apparatus including:

a pattern forming unit configured to form a predetermined pattern on the data sheet;

a pattern reading unit configured to apply a process liquid to the data sheet on which the predetermined pattern is formed by the pattern forming unit, and to read the predetermined pattern on the data sheet after applying the process liquid;

an expansion and contraction amount calculation unit configured to calculate an amount of expansion or contraction of the predetermined pattern read by the pattern reading unit; and

an image data expansion and contraction unit configured to expand or contract image data depending on the amount of expansion or contraction calculated by the expansion and contraction calculation unit.

According to another embodiment of the present invention, an image forming method using an image forming apparatus configured to form an image on a data sheet is provided, the method including the steps of:

forming a predetermined pattern on the data sheet;

applying a process liquid to the data sheet on which the predetermined pattern is formed;

reading the predetermined pattern on the data sheet after applying the process liquid;

calculating an amount of expansion or contraction of the read predetermined pattern; and

expanding or contracting image data depending on the calculated amount of expansion or contraction.

According to another embodiment of the present invention, an image forming method using an image forming apparatus configured to form an image on a data sheet is provided, the method including the steps of:

reading a surface texture of the data sheet;

applying a process liquid to the data sheet;

reading a pattern of the surface texture of the data sheet after applying the process liquid;

calculating an amount of expansion or contraction of the read pattern; and

expanding or contracting image data depending on the calculated amount of expansion or contraction.

Other objects, features and advantages of the present invention will become more apparent from the following detailed description when read in conjunction with the accompanying drawings.

### BRIEF DESCRIPTION OF THE DRAWINGS

FIG. 1 is a diagram showing an example of an outline configuration of an image forming apparatus of an embodiment;

FIG. 2 is a diagram showing an example of a functional configuration of an image forming apparatus of an embodiment;

FIGS. 3A through 3D are diagrams to illustrate variation of an image size in a conventional method;

FIGS. 4A through 4E are diagrams to illustrate variation of an image size in an embodiment; and

FIG. 5 is a flowchart of image forming processing in an embodiment.

### DETAILED DESCRIPTION OF THE PREFERRED EMBODIMENTS

A description is given, with reference to the accompanying drawings, of respective embodiments of the present invention.

<Outline Configuration of Image Forming Apparatus>

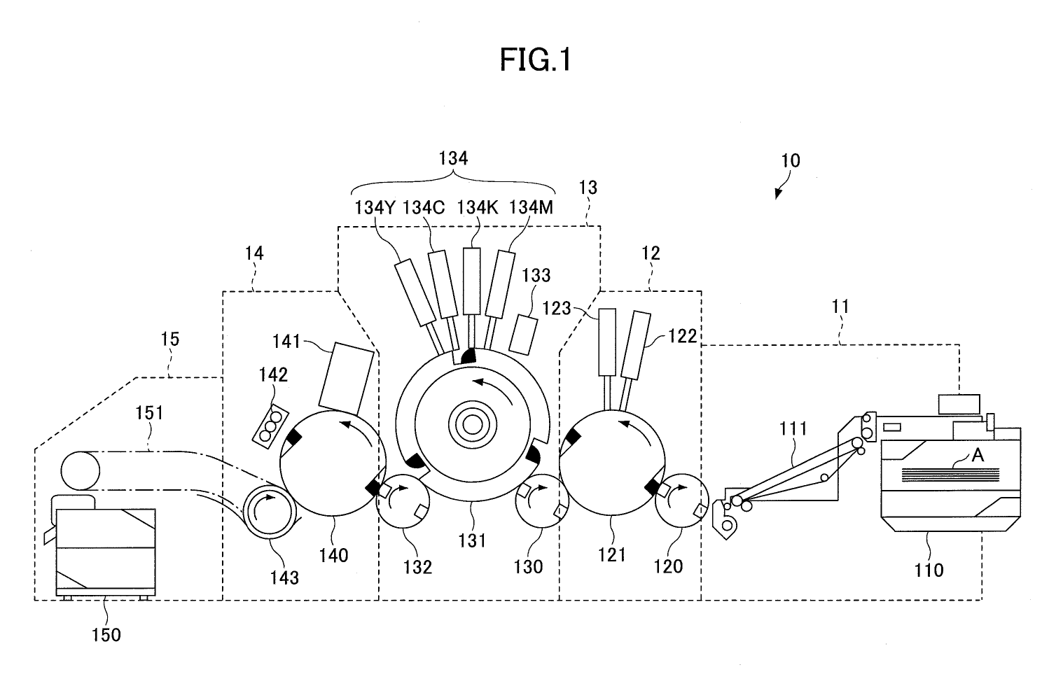

FIG. 1 is a diagram showing an example of an outline configuration of an image forming apparatus of an embodiment. An image forming apparatus 10 shown in FIG. 1 is, for example, an ink-jet recording apparatus that forms an image on a recording medium by using ink or process liquids and the like. Here, the recording medium means, for example, a medium on which an image or a document is recorded by droplets such as the ink, and a description is given by using a data sheet as an example of the recording medium hereinafter.

As shown in FIG. 1, the image forming apparatus 10 includes a paper feeding part 11, a process liquid providing part 12, an ink striking part 13, a dry part 14, and a paper ejection part 15.

The paper feeding part 11 feeds a data sheet A to record an image. The paper feeding part 11 includes a paper feeding rack 110 and a feeder board 111 coupled to the paper feeding rack 110. The feeder board 111 is provided in front of the paper feeding rack 110 (i.e., on the left side of the paper feeding rack 110 in the example of FIG. 1). The data sheets A in the paper feeding rack 110 are sent out to the feeder board 111 one by one.

The process liquid supplying part 12 supplies a process liquid onto the data sheet A. The process liquid supplying part 12 is configured to include a transfer cylinder 120, an impression cylinder (process liquid, penetration inhibitor drum) 121, a marking discharge head 122, and a process liquid discharge head 123.

The transfer cylinder 120 transfers the data sheet A sent from the feeder board 111 to the impression cylinder 121. In a position opposite to the surface of the impression cylinder 121, the marking discharge head 122 and the process liquid discharge head 123 are sequentially provided from the upper stream side in a rotation direction (i.e., in a counterclockwise direction in the example of FIG. 1).

The marking discharge head 122 records a pattern for size measurement (recording pattern) such as a dot, a group of dots and a grid line and the like onto the data sheet A on the impression cylinder 121.

Here, the pattern for size measurement is preferably to be a pattern that people have difficulty visually recognizing or cannot visually recognize, but a machine and the like can read. For example, a minute dot, a color difficult to visually recognize such as yellow, a pattern formed by a liquid and the like made visible only by using a black light are available. In the present embodiment, by repeatedly recording this pattern for size measurement, for example, at equal distances on the data sheet A, an amount of expansion and/or contraction (i.e., a ratio of expansion and/or contraction) of the data sheet A caused by the process liquid is obtained. Here, the ratio of expansion and/or contraction means a ratio of expansion and/or contraction of the data sheet A that has absorbed, for example, water and the like.

Here, the marking discharge head 122 may be replaced with a sensor that reads the surface texture of the data sheet A. That is to say, for example, there are minute surface irregularities (i.e., surface texture of paper, or fingerprints of paper) that can be observed by a microscope and the like on a surface of a piece of paper, and the same surface texture (or fingerprint) is never repeated even in the same piece of paper. Accordingly, by reading such a surface texture preliminarily, the amount of expansion or contraction of the data sheet can be obtained from shape change of the surface texture after applying the process liquid. Here, as an example of the surface texture of paper, Japanese Patent Application Publication No. 2007-004479 can be referred to.

The process liquid discharge head 123 discharges the process liquid to strike the data sheet A held on the impression cylinder 121. The process liquid, for example, has a function of agglutinating a color material included in the ink discharged from ink striking heads 134.

As mentioned above, in the present embodiment, a droplet striking method is used as a means of providing the process liquid for the recording sheet A, but the present invention is not limited to this. For example, the process liquid may be provided by using various methods such as a roller application method, a spray method and the like. Here, in a case of the droplet striking method, it is possible to selectively provide the penetration inhibitor only for the ink striking location and around the ink striking location.

The ink striking part 13 strikes the data sheet A with droplets of the ink and the like. The ink striking part 13 is configured to include a transfer cylinder 130, an impression cylinder 131, a transfer cylinder 132, a sensor 133, and ink striking heads 134.

The transfer cylinder 130 is provided between the impression cylinder (i.e., process liquid, penetration inhibitor drum) 121 and the impression cylinder (i.e., drawing drum) 131, so as to face and contact the impression cylinders 121, 131. The transfer cylinder 130 receives the data sheet A with the process liquid on it from the impression cylinder 121, and transfers the data sheet A on which a solid or semi-solid aggregation processing agent layer is formed to the impression cylinder 131.

At positions facing the surface of the impression cylinder 131, the sensor 133 and the ink striking heads 134Y, 134C, 134K and 134M (which may be called “ink striking heads 134” hereinafter) are sequentially provided from the upstream side in a rotation direction (i.e., in a counterclockwise direction in the example of FIG. 1).

The sensor 133 is provided upstream of the ink striking heads 134, and reads the pattern for size measurement or the surface texture of the data sheet A. With this, before recording an image on the data sheet A, the amount of expansion and/or contraction (i.e., the ratio of expansion and contraction) of the data sheet A can be understood. For example, it may be better to obtain the amount of expansion and/or contraction of the data sheet in the conveyance direction of the data sheet A and the direction perpendicular to the conveyance direction, respectively.

The ink striking head 134 includes, for example, four ink striking heads 134M, 134K, 134C and 134Y respectively corresponding to four colors of magenta (M), black (B), cyan (C) and yellow (Y) at positions facing the surface of the impression cylinder 131 sequentially arranged from the upstream in the counterclockwise direction in the example of FIG. 1. The ink striking heads 134M, 134K, 134C and 134Y discharge the ink droplets of the respective colors onto the data sheet A held by the impression cylinder 131.

Here, a recording head of a liquid discharging type (i.e., a liquid discharge head) is applied to the ink striking heads 134 as well as the process liquid discharge head 123. Moreover, an ink storage and loading part is provided in the ink striking heads 134, and the ink striking heads 134 include corresponding ink tanks to store ink to supply to a discharge part of the ink striking heads 134.

The ink storage and loading part includes an alarm unit (e.g., a display unit, an alarm sound generation unit and the like) that informs a user that a liquid remaining amount of the ink tank is reduced, and a mechanism that prevents erroneous loading between the respective colors. The ink tanks are in communication with the corresponding ink striking heads 134Y, 134C, 134K and 134M through required passages, and supply inks corresponding to the respective ink striking heads 134Y, 134C, 134K and 134M.

The ink striking heads 134 form an image by striking the data sheet A with the inks corresponding to the colors, in accordance with an image signal. In the present embodiment, the ink striking heads 134 detect the pattern for size measurement or the surface texture by the sensor 133, and record an image based on an expanded and contracted image depending on a calculated amount of expansion and contraction of the data sheet A.

Here, the ink striking heads 134 have a length corresponding to a maximum width of an image formation area of the data sheet A held by the impression cylinder 131, and have a full-line type head that includes plural nozzles for ink discharge on the ink discharge aspect arranged across the full width of the image formation area. Furthermore, each of the ink striking heads 134 is fixed and installed so as to extend in a direction perpendicular to the rotation direction of the impression cylinder 131 (i.e., the conveyance direction of the data sheet A).

The full-line type head includes a nozzle line that covers the full width of the image formation area of the data sheet A for each of the ink colors. Accordingly, the ink striking heads 134 can record a primary image on the image formation area of the data sheet A with one motion (i.e., vertical scanning) that is relative motion in the conveyance direction of the data sheet A (i.e., the vertical scanning direction). This makes high-speed printing possible and improves printing productivity compared to a serial (shuttle) type head that goes and returns in a direction perpendicular to the conveyance direction of the data sheet A.

Here, the image forming apparatus 10 can record, for example, an image on a data sheet up to a medium octavo size (i.e., 939*636 mm), and a drum with a diameter of 810 mm corresponding to a data sheet 720 mm in length, for example, is used as the impression cylinder 131. In addition, an ink discharge volume of the individual ink striking head 134 is, for example, 2 pl, and a recording density is, for example, 1200 dpi in both of the main scanning direction (i.e., the width direction of the data sheet A) and the vertical direction (i.e., the conveyance direction of the data sheet A).

Moreover, the present embodiment, as mentioned above, shows a configuration of four colors, but a combination of the ink colors and the number of colors is not limited to the present embodiment. For example, inks of R (red), G (green) and B (blue), light color ink, deep color ink, special color ink and the like may be added if necessary. Furthermore, a head that discharges light system ink such as light cyan, light magenta and the like may be added, and an arrangement order of the respective color heads is not specifically limited.

The dry part 14 dries an image formed on the data sheet A. The dry part 14 is configured to include an impression cylinder 140, a print detection part 141, a dry unit 142, and a paper ejection cylinder 143. The impression cylinder (i.e., dry drum) 140 receives the data sheet A by way of a transfer cylinder 132 that faces the impression cylinder 131 and the impression cylinder 140.

At a position facing the surface of the impression cylinder 140, the print detection part 141 and the dry unit 142 are sequentially provided from the upstream side in the rotation direction of the impression cylinder 140 (i.e., in the counterclockwise direction in the example in FIG. 1). The print detection part 141 includes an image sensor (e.g., a line sensor and the like) to image a print result of the ink striking part 13, and detects a poor discharge such as clogging of a nozzle and the like from a droplet-struck image that has been read.

The dry unit 142 includes a hot air dryer that can control a temperature and an air volume in a predetermined range, and blow the air (a hot wind) heated by the hot air dryer against the surface of the data sheet A, when the data sheet A on the impression cylinder 140 passes through the facing position.

Here, as a heating and drying method, it may be possible to heat the data sheet A from the lower surface by using a heat generator such as a heater and the like inside the impression cylinder 140, to heat the data sheet A by blowing the hot wind against the upper surface thereof, and to heat the data sheet A from the upper surface by using an infrared heater. In addition, combining these heating and drying methods is possible.

The paper ejection part 15 ejects the data sheet A on which an image is formed. The paper ejection part 15 is configured to include a paper ejection rack 150, and a chain 151 for paper ejection. The paper ejection rack 150 stores the data sheets A.

The paper chain 151 for paper ejection winds around between a sprocket provided at the paper ejection cylinder 143 that receives the data sheet A on which the image is fixed and a sprocket provided above the paper ejection rack 150, includes plural grippers for paper ejection, and ejects the data sheet A from the paper ejection cylinder 143 to the paper ejection rack 150.

<Functional Configuration of Image Forming Apparatus>

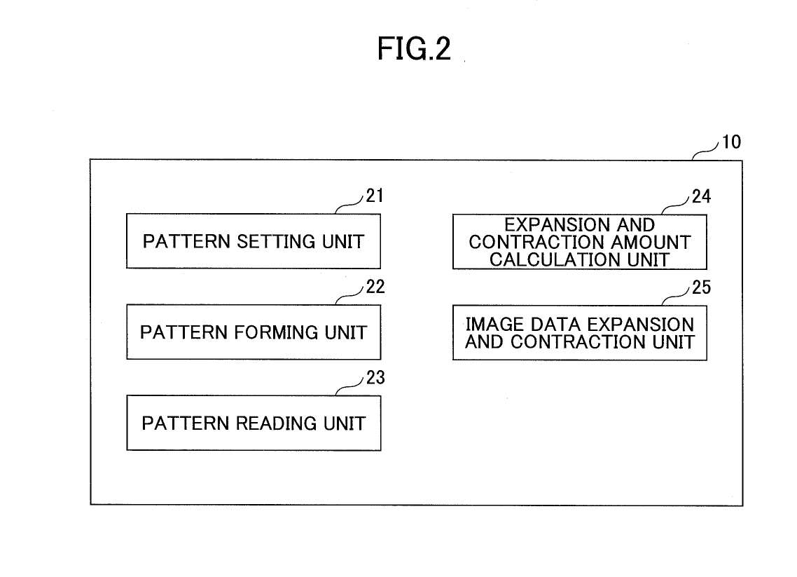

Next, a description is given about an example of a functional configuration of the above-mentioned image forming apparatus 10 with reference to FIG. 2. FIG. 2 is a diagram showing an example of a functional configuration of the image forming apparatus of the present embodiment.

As shown in FIG. 2, the image forming apparatus 1 is configured to include a pattern setting unit 21, a pattern forming unit 22, a pattern reading unit 23, an expansion and contraction amount calculation unit 24, and an image data expansion and contraction unit 25.

The pattern setting unit 21 sets a pattern for size measurement to be formed by the pattern forming unit 22. The pattern setting unit 21 sets, for example, contents of the pattern (e.g., a size of a dot, a color of the dot, an arrangement of the dots, a grid line and the like), a formation area of the pattern, a sheet size and a kind of the data sheet A, a kind of the process liquid, an application area of the process liquid, and the like. Here, the setting in the pattern setting unit 21 may be preliminarily set before carrying out the process in the present embodiment, and may be arbitrarily changed at a predetermined timing by a user and the like.

The pattern forming unit 22 generates the pattern for size measurement to be formed on the data sheet A, based on the setting information set by the pattern setting unit 21. Here, the pattern forming unit 22, for example, corresponds to the marking discharge head 122 and the like in FIG. 1.

The pattern forming unit 22 forms, for example, the pattern for size measurement on a part or the entire surface of the data sheet A. Here, the part of the data sheet A may be, for example, an area including a predetermined range of a rectangle or a circle that is based on the center of the data sheet A. In this manner, it may be better that the pattern setting unit 21 sets where the pattern for size measurement is to be formed.

Moreover, the pattern for size measurement is preferably to be a pattern that a machine and the like can read but people hardly visually recognize or cannot visually recognize. For example, the pattern may be formed by minute dots or a color difficult to visually recognize such as yellow or a liquid visible only by using a black light and the like.

Furthermore, the pattern for size measurement may be formed to be a pattern in which at least one of predetermined dots, a group of the dots, a square pattern of grid lines with a predetermined width and the like are arranged at equal distances, or a pattern in which at least one of dots of a predetermined color, a group of the dots, a square pattern of grid lines with a predetermined color and the like are arranged at equal distances.

The pattern reading unit 23 applies the process liquid to the data sheet A on which the pattern for size measurement is formed by the pattern forming unit 22, and reads the pattern for size measurement on the data sheet A after the process liquid has been applied. In addition, the pattern reading unit 23 may read the surface texture of the data sheet A by the sensor before applying the process liquid, and may read a shape change of the surface texture of the data sheet A after applying the process liquid. Here, the pattern reading unit 23, for example, corresponds to the sensor 133 and the like in FIG. 1.

The expansion and contraction amount calculation unit 24 calculates an amount of expansion or contraction (i.e., an expansion and contraction ratio) of the pattern for size measurement read by the pattern reading unit 23. The expansion and contraction amount calculation unit 24 calculates the amount of expansion or contraction based on a pattern position or a distance change and the like of the pattern for size measurement.

Here, it may be better that the amount of expansion or contraction is obtained, for example, for both the conveyance direction of the data sheet A and the direction perpendicular to the conveyance direction. Moreover, with respect to the amount of expansion or contraction, one value may be obtained for the entire surface of the data sheet A; or by dividing the data sheet A into predetermined areas, values may be obtained for the respective divided areas. Or, a value may be obtained for a specified area (e.g., only an area on the data sheet A to which the process liquid is applied and the like).

In this way, by obtaining the amount of expansion or contraction for the respective areas on the data sheet A, for example, the amount of expansion or contraction for each area can be obtained with a high degree of accuracy both for variation of the amount of expansion or contraction caused by uniform application of the process liquid on the data sheet A, and for variation of the amount of expansion or contraction caused by the application unevenness of the process liquid on the data sheet A.

The image data expansion and contraction unit 25 expands or contracts image data depending on the amount of expansion or contraction calculated by the expansion and contraction amount calculation unit 24. Because the image data expansion and contraction unit 25 can obtain the amount of expansion or contraction for each of the divided areas divided by the expansion and contraction amount calculation unit 24, the image data expansion and contraction unit 25 expands or contracts the image data depending on the amount of expansion or contraction of the respective areas. This makes it possible to perform a high-accuracy correction for variation of an image size, for example, caused by the expansion and/or contraction of the data sheet A.

<Variation of Image Size in Conventional Method>

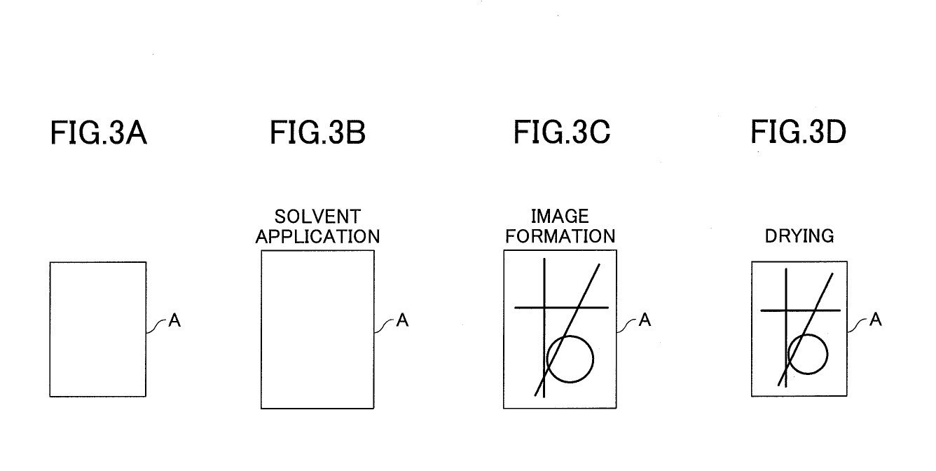

Next, a description is given about variation of an image size in a conventional method in a condition where the process liquid is applied to a data sheet. FIGS. 3A through 3D are diagrams to illustrate the variation of the image size in the conventional method.

FIG. 3A shows a data sheet A to record an image, and FIG. 3B shows a state where a solvent as a process liquid is applied to the data sheet A shown in FIG. 3A. Moreover, FIG. 3C shows a state where an image is formed on the expanded data sheet A, and FIG. 3D shows a state where the data sheet A is dried up.

Conventionally, if the solvent is applied to the data sheet A shown in FIG. 3A, as shown in FIG. 3B, a sheet size of the data sheet A expands by absorbing water. Furthermore, as shown in FIG. 3C, image data corresponding to a sheet size before the expansion is formed on the data sheet A in an expanded state. Accordingly, if the data sheet A in a state shown in FIG. 3C is contracted by losing the water due to drying, as shown in FIG. 3D, a more reduced image than a desired size of the image data is formed.

<Variation of Image Size in Present Embodiment>

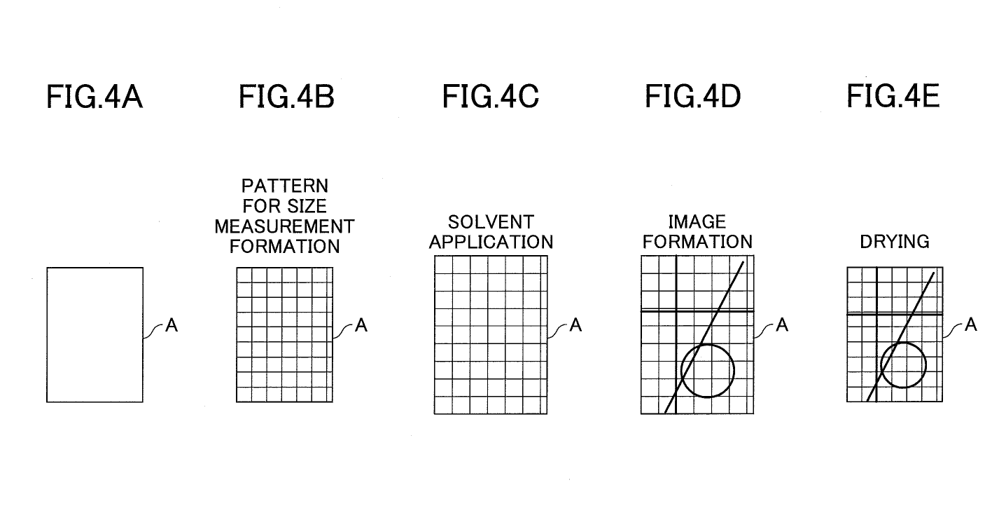

Next, a description is given about variation of an image size in the present embodiment in a condition where a process liquid is applied to a data sheet. FIGS. 4A through 4E are diagrams to illustrate the variation of the image size in the present embodiment.

FIG. 4A shows a data sheet A to record an image, and FIG. 4B shows the data sheet A on which a pattern for size measurement (i.e., a record pattern) is formed. Moreover, FIG. 4C shows a state where a solvent as a process liquid is applied to the data sheet A shown in FIG. 4B. Furthermore, FIG. 4D shows a state where an image is formed on the expanded data sheet A, and FIG. 4E shows a state where the data sheet A is dried up.

In the present embodiment, for the data sheet A of a paper size shown in FIG. 4A, a pattern for size measurement is formed on the entire data sheet A as shown in FIG. 4B. Here, the pattern for size measurement is formed by the pattern forming unit 22, for example, by using a color difficult to visually recognize such as yellow (Y) or grid lines of a liquid and the like that are made visible only by using a black light. Here, the pattern for size measurement of the grid lines can be read by a machine and the like.

Next, as shown in FIG. 4C, when a solvent is applied to the data sheet A on which the pattern for size measurement is formed, the data sheet A absorbs the solvent and the paper size expands. At this time, the pattern for size measurement of the grid lines also expands conforming with the expansion of the data sheet A.

Next, the grid lines in an expanded state are read, and image data are expanded depending on the amount of expansion (i.e., the ratio of expansion) of the read grid lines. Then, as shown in FIG. 4D, an image expanded conforming with the expanded grid lines is formed on the data sheet A.

By doing this, in the present embodiment, as shown in FIG. 4E, even if the data sheet A contracts by losing the water due to drying, because the image also contracts in accordance with the contraction of the data sheet A, an image of a desired size can be obtained.

Here, in FIGS. 4A through 4E, the pattern of the grid lines is shown as an example of the pattern for size measurement formed by the pattern forming unit 22, but the present invention is not limited to this example. For example, it is possible to use dots of a predetermined size and color, a pattern of dot groups that are arranged at equal distances, a pattern using other straight lines, curved lines, design, marks and the like, and a pattern combining them.

Furthermore, in the present embodiment, without forming the pattern by the pattern forming unit 22, for example, the image data formed on the data sheet A may be expanded and contracted, conforming with the amounts of expansion and contraction of the read surface texture as discussed above, by using the surface texture pattern of the data sheet A. In addition, by using both the pattern formed by the pattern forming unit 22 and the surface texture pattern, the image data formed on the data sheet A may be expanded and contracted.

<Flow of Image Forming Process of Present Embodiment>

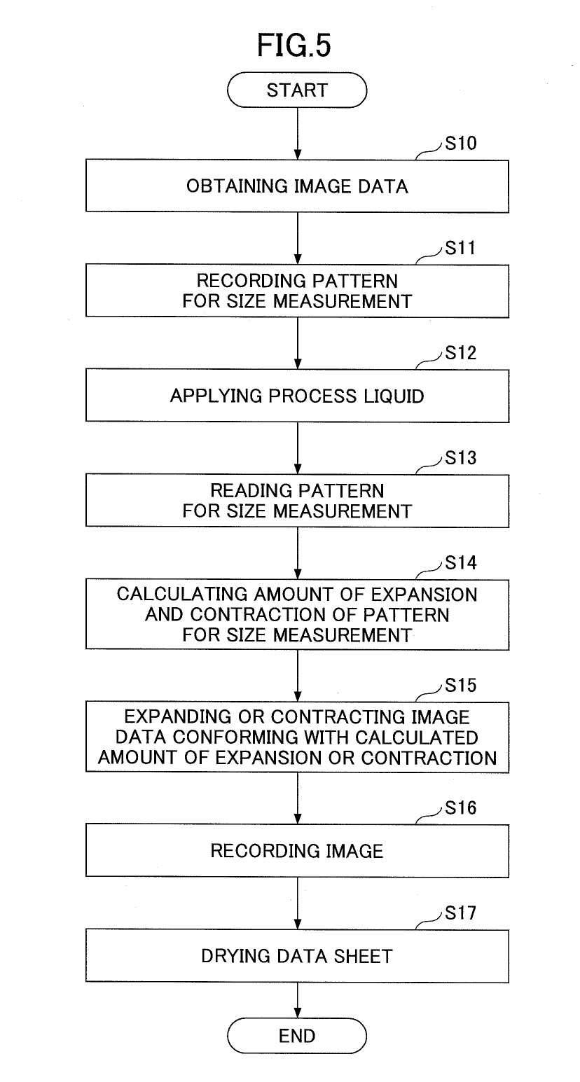

Next, a description is given about a flow of an image forming process that forms an image by applying the process liquid of the present embodiment with reference to FIG. 5. FIG. 5 is a flowchart showing the image forming process of the present embodiment.

As shown in FIG. 5, the image forming apparatus 10, when obtaining image data (S10), generates a pattern for size measurement for a data sheet A by using the pattern forming unit 22 based on setting information set by the pattern setting unit 21, and records the pattern for size measurement on the data sheet A (S11).

Next, the image forming apparatus 10 applies a process liquid to the data sheet A on which the pattern for size measurement is recorded (S12), and reads the pattern for size measurement after the process liquid has been applied by the pattern reading unit 23 (S13).

Next, the expansion and contraction amount calculation unit 24 calculates an amount of expansion or contraction of the pattern for size measurement read by the pattern reading unit 23. Next, the image data expansion and contraction unit 25 expands or contracts the image data depending on the amount of expansion or contraction calculated by the expansion and contraction amount calculation unit 24 (S15).

The image forming apparatus 10 records an image on the data sheet A based on the image data expanded or contracted by the image data expansion and contraction unit 25 (S16), dries the data sheet A on which the image is recorded (S17), ejects the dried data sheet A, and finishes the process. This makes it possible to obtain an image that maintains a desired size on the data sheet A.

As mentioned above, in accordance with the present embodiment, it is possible to perform a high-accuracy correction depending on the individual data sheet in real time. Moreover, it is possible to obtain a correction amount for each predetermined area in the paper surface without being affected by a lot number difference, which makes it possible to perform a high-accuracy correction responding to dispersion of amounts of change in the paper surface and application unevenness of the process liquid.

As mentioned above, according to the embodiments of the present invention, it is possible to provide an image forming apparatus and an image forming method that can implement a high-precision correction depending on an individual data sheet in real time.

As discussed above, an image forming apparatus and an image forming method are described in the embodiments. However, the present invention is not limited to the specifically disclosed embodiments, and variations and modifications may be made without departing from the scope of the present invention.

For example, in the embodiments, an example of obtaining an amount of expansion and expanding image data is mainly described. However, if the data sheet A is contracted by a process, obtaining an amount of contraction and contracting image data depending on the obtained amount of contraction are also possible.

The present application is based on Japanese Priority Patent Application No. 2011-163610, filed on Jul. 26, 2011, the entire contents of which are incorporated herein by reference.

What is claimed is:

1. An image forming apparatus configured to form an image on a data sheet, the apparatus comprising:
a pattern forming unit configured to form a predetermined pattern on the data sheet;
a pattern reading unit configured to apply a process liquid to the data sheet on which the predetermined pattern is formed by the pattern forming unit, and to read the predetermined pattern on the data sheet after applying the process liquid;
an expansion and contraction amount calculation unit configured to calculate an amount of expansion or contraction of the predetermined pattern read by the pattern reading unit; and
an image data expansion and contraction unit configured to expand or contract image data depending on the amount of expansion or contraction calculated by the expansion and contraction calculation unit.

2. An image forming apparatus as claimed in claim 1,
wherein the pattern forming unit is configured to form the predetermined pattern in part of a surface of the data sheet.

3. An image forming apparatus as claimed in claim 1,
wherein the pattern forming unit is configured to form the predetermined pattern on a whole surface of the data sheet.

4. The image forming apparatus as claimed in claim 1,
wherein the expansion and contraction amount calculation unit is configured to calculate the amount of expansion or contraction based on a change of at least one of a position and a distance of the predetermined pattern.

5. The image forming apparatus as claimed in claim 1,
wherein the expansion and contraction amount calculation unit is configured to divide the data sheet into predetermined areas, and to calculate the amount of expansion or contraction for each of the divided areas.

6. The image forming apparatus as claimed in claim 1,
wherein the predetermined pattern is formed by arranging at least one of dots of a predetermined size, groups of the dots, and grid lines of a predetermined width at equal distances.

7. The image forming apparatus as claimed in claim 1,
wherein the predetermined pattern is formed by arranging at least one of dots of a predetermined color, groups of the dots, and grid lines of a predetermined color at equal distances.

8. The image forming apparatus as claimed in claim 1,
wherein the predetermined pattern is formed by arranging at equal distances at least one of dots formed by using a predetermined liquid, groups of the dots, and grid lines formed by using the predetermined liquid.

9. An image forming method using an image forming apparatus configured to form an image on a data sheet, the method comprising the steps of:
forming a predetermined pattern on the data sheet;
applying a process liquid to the data sheet on which the predetermined pattern is formed;
reading the predetermined pattern on the data sheet after applying the process liquid;
calculating an amount of expansion or contraction of the read predetermined pattern; and
expanding or contracting image data depending on the calculated amount of expansion or contraction.

10. The image forming method as claimed in claim 9,
wherein the predetermined pattern is formed in part of a surface of the data sheet.

11. The image forming method as claimed in claim 9,
wherein the predetermined pattern is formed on a whole surface of the data sheet.

12. An image forming method using an image forming apparatus configured to form an image on a data sheet, the method comprising the steps of:
reading a surface texture of the data sheet;
applying a process liquid to the data sheet;
reading a pattern of the surface texture of the data sheet after applying the process liquid;
calculating an amount of expansion or contraction of the read pattern; and
expanding or contracting image data depending on the calculated amount of expansion or contraction.

13. The image forming method as claimed in claim 12,
wherein the predetermined pattern is formed in part of a surface of the data sheet.

14. The image forming method as claimed in claim 10,
wherein the predetermined pattern is formed on a whole surface of the data sheet.
